(19) United States
(12) Patent Application Publication
(10) Pub. No.: US 2011/0162784 A1
(43) Pub. Date: Jul. 7, 2011

(54) MEMBRANE ELECTRODE ASSEMBLY FABRICATION

(75) Inventors: Jeremy W. Dabel, Sacramento, CA (US); Jerrold E. Franklin, Sacramento, CA (US)

(73) Assignee: ALTERGY SYSTEMS, Folsom, CA (US)

(21) Appl. No.: 12/979,523

(22) Filed: Dec. 28, 2010

Related U.S. Application Data
(62) Division of application No. 11/516,948, filed on Sep. 6, 2006.

(51) Int. Cl. B32B 38/10; B32B 37/00

(52) U.S. Cl. 156/182; 156/263

(57) ABSTRACT

A method for fabricating MEAs employing such gas diffusion layers and or gas diffusion electrodes that address the problems attendant to conventional methods. Due to the mechanically unstable nature of the electrolyte membrane material, it is advantageous to attach or bond the electrolyte membrane material to a supportive substrate before being sized for incorporation into a fuel cell. The GDL or GDE is used as the supportive substrate for the electrolyte membrane material.

### CROSS-REFERENCE TO RELATED APPLICATIONS

This application is a divisional of U.S. patent application Ser. No. 11/516,948 filed on Sep. 6, 2006, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention relates to polymer electrolyte membrane (PEM) fuel cells and methods for producing components thereof. More particularly, this invention relates to a method for producing membrane electrode assemblies for polymer electrolyte membrane fuel cells.

2. Description of Prior Art

A polymer electrolyte membrane fuel cell is an electrochemical device comprising an anode electrode, a cathode electrode and an electrolyte in the form of a thin polymeric membrane disposed between the anode electrode and the cathode electrode. Individual polymer electrolyte membrane fuel cells or fuel cell units are stacked with bipolar separator plates separating the anode electrode of one fuel cell unit from the cathode electrode of an adjacent fuel cell unit to produce polymer electrolyte membrane fuel cell stacks. Conventionally, electrodes are a catalyzed layer bonded or applied on either side of the solid polymer electrolyte membrane to produce a membrane/electrode assembly (MEA). In this form, the MEA is commonly referred to as a 3-layer MEA; the three layers being polymer electrolyte membrane and the two catalyst/electrode layers.

The gas diffusion layer (GDL) is a porous, electron-conductive layer that is disposed between a catalyst layer on the MEA and the bipolar separator plates (current collectors). The porous nature of the material comprising the electrode ensures effective diffusion of each reactant gas to the catalyst on the MEA. In addition, the porous nature of the material also assists in water management during operation of the fuel cell. Too little water causes a high internal resistance due to low humidification of the polymeric membrane while too much water causes flooding of the fuel cell by the water.

A gas diffusion electrode (GDE) is similar to a GDL in that it is a porous, electron-conductive layer that is disposed between the polymer electrolyte membrane and the bipolar separator plates wherein a catalyzed layer is bonded or applied to the porous, electron-conductive material before assembly. A variety of methods for producing gas diffusion electrodes are known including filtration, powder vacuum deposition, spray deposition, electrodeposition, casting, extrusion, and rolling and printing. However, some of these methods are very difficult to scale up to high rate production to fabricate gas diffusion electrodes with good surface conductivity, gas permeability, uniformity, and long-term hydrophobic and hydrophilic stability.

Patents of general interest include, for example, U.S. Pat. Nos. 4,849,253; 5,474,857; 5,783,325; 5,935,643; 5,998,057; 6,376,111; 6,627,035; 6,641,862; 6,723,462; 6,733,914; 6,740,445; and 7,056,612. Each of the references, patents, standards, etc. cited in this application is incorporated by reference in its entirety.

To provide sufficient ionic conductivity within the catalyst layer of the gas diffusion electrode, the platinum/carbon powder catalyst must be intimately intermixed with liquid ionomer electrolyte. Thus, the catalyst layer may be described as a Pt/C/ionomer composite that achieves proton mobility while maintaining adequate electronic conductivity to result in a low contact resistance with the gas diffusion layer. To reduce overall costs, it is desired to maintain Pt metal loading at a minimum.

The proton conducting polymeric membrane is the most unique element of the polymer electrolyte membrane fuel cell. The membrane commonly employed in most recent polymer electrolyte membrane fuel cell technology developments is made of a perfluorocarbon sulfonic acid ionomer such as NAFION® by DuPont. W. L. Gore produces similar materials as either commercial or developmental products. These membranes exhibit very high long-term chemical stability under both oxidative and reductive environments due to their Teflon-like molecular backbone. This membrane, when wet with water, can serve at the same time as an effective gas separator between fuel and oxidant. If allowed to dry out, gases can pass through the membrane and the fuel cell can be destroyed as hydrogen and oxygen combine in catalytic combustion.

A major step for fabricating MEAs is to catalyze either the gas diffusion electrode or the polymer electrolyte membrane. In either case, an electron conducting backing commonly known as a gas diffusion layer is placed on each side of the polymer electrolyte membrane with a catalyst/electrolyte ionomer layer between each gas diffusion layer and the membrane to form a membrane electrode assembly. This type of MEA assembly in which gas diffusion layers are incorporated either as a GDL or GDE into the assembly is commonly referred to as a 5-layer MEA; the five layers being the polymer electrolyte membrane, the two catalyst/electrodes on each side of the polymer electrolyte membrane and the two GDLs on the outside of the catalyst/electrodes. Currently, two methods by various developers are used to put the catalyst/electrolyte ionomer layer between the gas diffusion electrode and the polymer electrolyte membrane. One is a direct deposition method; the other is an indirect deposition method.

In the direct deposition method, the catalyst/electrolyte ionomer layer is directly applied to the polymer electrolyte membrane by coating methods, chemical vapor deposition (CVD), physical vapor deposition (PVD), or electrochemical deposition (ECD). The CVD, PVD and ECD methods are not useful in a fuel cell with a gas phase fuel because these methods cannot deposit the electrolyte ionomer with the catalyst particles, as a result of which there is no electrolyte between the catalyst particles in the gas phase. Electrochemical deposition has been used to make MEAs for a direct methanol fuel cell, in which the electrolyte ionomer is not necessary to exist in the catalyst layer because of the liquid phase fuel. In gas phase fuel cells, the catalyst ink can be directly deposited on the polymer electrolyte membrane surface if the membrane does not wrinkle after touching the solvent in the catalyst ink. Coating methods, such as painting, spraying, screen-printing, etc. are generally used to put catalyst/ionomer ink on the membrane surface. These methods create good contact between the catalyst layer and the electrolyte membrane. To maintain good contact in the three phase (gas/electrolyte/catalyst) area, crack-free gas diffusion backing is required to support the catalyst layer. In the fuel cell, the ionic impedance can be a major contributor in the reduction of efficiency in comparison to electrical loss. In other words, the contact between the gas diffusion layer and the catalyst layer is for current collection, that is, electrical connection. The contact between the catalyst layer and the electrolyte membrane is for ionic transportation. As is seen, the direct deposition method reduces the ionic impedance in the fuel cell. The requirement for this method is that the polymer electrolyte membrane must not be sensitive to the ink solvent. A certain clamp force must also be maintained to reduce the electrical resistance between the catalyst layer and the gas diffusion backing.

While electrolyte membrane material can be produced on a continuous basis as rolled material and handled on the roll, in order to produce individual MEAs for inclusion in a fuel cell stack the electrolyte membrane must be cut to a size smaller than the rolled material. This cutting to size and subsequent handling is problematic due to the nature of the electrolyte membrane itself, it being on the order of 10 micrometers to 100 micrometers thick and sensitive to changes in humidity which can cause it to change dimensions and shape.

In indirect deposition methods, the catalyst layer is deposited on a substrate that then decals to the electrolyte membrane or on the gas diffusion electrode then sandwiches to the electrolyte membrane by hot pressing, hot rolling, or laminating. In one known implementation of the decal method, a layer of catalyst ink is brushed onto a Teflon-coated fiber substrate. After drying, the ink layer with the substrate is hot pressed on a NAFION electrolyte membrane. Although resulting in good contact between the catalyst layer and the electrolyte membrane, this method is limited to producing only small electrodes due to the problem of catalyst releasing from the substrate. In addition, it is very difficult to scale up for mass production. A certain clamp force is also required to reduce the electrical resistance between the catalyst layer and the gas diffusion layer.

Catalyst ink deposition on a gas diffusion electrode is another method of producing an MEA. In this method, catalyst ink is deposited onto the gas diffusion electrode which is then hot-pressed, hot-rolled, or laminated to the polymer electrolyte membrane. This method produces MEAs having good electrical contact between the gas diffusion electrode and the catalyst layer as well as the catalyst layer and the electrolyte membrane. The critical requirement with this method is that the gas diffusion electrode must be crack-free; otherwise the catalyst ink will be lost in the cracks after deposition of the gas diffusion electrode. Consideration must also be given to optimization of the hot-pressing, hot-rolling or laminating force so as to preclude crushing the gas diffusion electrode.

### SUMMARY OF THE INVENTION

It is an object of this invention is to provide a method for fabricating MEAs employing such gas diffusion layers and or gas diffusion electrodes that address the problems attendant to conventional methods as discussed hereinabove. Due to the mechanically unstable nature of the electrolyte membrane material, it is advantageous to attach or bond the electrolyte membrane material to a supportive substrate before being sized for incorporation into a fuel cell. In the case of the instant invention, this takes the form of using the GDL or GDE as the supportive substrate. By the use of this invention, MEAs can be more readily mass produced and therefore produced at lower costs than hand assembled products that are heretofore the norm.

In one embodiment, electrolyte membrane material is coated on only one side with the catalyst/electrode material as described hereinabove or other similar manner known to the art, in a continuous process. The catalyst/electrode material coats the entire surface of the electrolyte membrane material. The catalyst/electrode material coats the electrolyte membrane material over its entire surface and requires no border areas as is typical with MEA fabrication and is well known to those familiar with the art. GDL material is then attached or bonded by hot rolling or laminating over the entire surface as was the catalyst/electrode material on the electrolyte membrane material, forming a unified structure. The electrolyte membrane material is thus supported and can be more easily handled than separate electrolyte membrane material. This “precursor-MEA” is essentially 3-layer MEA; the three layers, in this case, being the electrolyte membrane material, the catalyst/electrode and the GDL. This assembly is then sized to the appropriate dimensions for inclusion in a fuel cell.

In another embodiment, GDL material is coated on only one side with the catalyst/electrode material as described hereinabove or other similar manner known to the art, in a continuous process, thus forming a gas diffusion electrode. The catalyst/electrode material coats the entire surface of the GDL material. Electrolyte membrane material is then attached or bonded by hot rolling or laminating over the entire surface as was the catalyst/electrode material on the GDL. Alternately, the electrolyte membrane material can be applied as an ionomer solution as described in U.S. Pat. No. 6,641,862, incorporated herein by reference in its entirety. Again, the electrolyte membrane material is thus supported and can be more easily handled than separate electrolyte membrane material. This “precursor-MEA” is essentially 3-layer MEA; the three layers, in this case, being the electrolyte membrane material, the catalyst/electrode and the GDL. This assembly is then sized to the appropriate dimensions for inclusion in a fuel cell.

A second GDL and catalyst/electrode is prepared in a similar manner. In one embodiment, GDE material is prepared as discussed hereinabove. The GDE is sized to the appropriate dimensions, registered with respect to the precursor-MEA and then attached or bonded by hot rolling or laminating to the precursor-MEA's electrolyte membrane material, thus forming a 5-layer MEA to be incorporated into a fuel cell. Alternately, the opposing GDE can be assembled at the same time the fuel cells is assembled and pressed together when the fuel cell or fuel cell stack is compressed.

In another embodiment, the second GDL and catalyst/electrode is prepared as the above discussed 3-layer precursor-MEA, sized to the appropriate dimensions, registered with respect to the first precursor-MEA and then attached or bonded by hot rolling or laminating the two precursor-MEA's electrolyte membrane material together thus forming a 5-layer MEA to be incorporated into a fuel cell.

An aspect of the invention is a membrane electrode assembly, comprising a first unified structure and a second unified structure adjacent to the first unified structure; wherein the first unified structure comprises: a first gas diffusion layer (GDL); a first catalyst/electrode layer adjacent to the first GDL; and a polymer electrolyte membrane (PEM) layer adjacent to the first catalyst/electrode later; wherein the first GDL, the first catalyst/electrode layer, and the PEM layer have identical planar dimensions; wherein the second unified structure comprises: a second GDL; and a second catalyst/electrode layer adjacent to the second GDL; wherein the second GDL and the second catalyst/electrode layer have identical planar dimensions; and wherein the second catalyst/electrode layer of the second unified structure contacts the PEM layer of the first unified structure.

In one embodiment of this aspect, planar dimensions of the second unified structure are smaller than planar dimensions of the first unified structure. In another embodiment, exposed portions of the PEM layer form a continuous border about a perimeter of the second unified structure.

Another aspect of the invention is a method of making a membrane electrode assembly, comprising: coating an electrolyte membrane with catalyst/electrode material; attaching gas diffusion layer (GDL) material over the coating of catalyst/electrode material to form a precursor material; sizing the precursor material; preparing a gas diffusion electrode (GDE) material; sizing the GDE material; and bonding the GDE material to the electrolyte membrane.

In one embodiment of this aspect, the size of the GDE material is smaller than the size of the precursor material. In another embodiment, the step of attaching GDL material is performed using a roll-bonding machine.

Another aspect of the invention is a membrane electrode assembly, comprising: a first unified structure; and a second unified structure adjacent to the first unified structure; wherein the first unified structure comprises: a first gas diffusion layer (GDL); a first catalyst/electrode layer adjacent to the first GDL; and a polymer electrolyte membrane (PEM) layer adjacent to the first catalyst/electrode layer; wherein the first GDL, the first catalyst/electrode layer, and the PEM layer have identical planar dimensions; wherein the second unified structure comprises: a second GDL; and a second catalyst/electrode layer adjacent to the second GDL; a polymer electrolyte membrane (PEM) layer adjacent to the second GDL; wherein the second GDL and the second catalyst/electrode layer have identical planar dimensions; and wherein the PEM layer of the second unified structure contacts the PEM layer of said first unified structure. In one embodiment of this aspect planar dimensions of the second unified structure are smaller than planar dimensions of the first unified structure.

Still another aspect of the invention is a method of making a membrane electrode assembly, comprising: coating an electrolyte membrane with catalyst/electrode material; attaching gas diffusion layer (GDL) material over the coating of catalyst/electrode material to form a precursor material; sizing the precursor material; wherein the sized precursor material has either a first size or a second size; wherein the first size is larger than the second size; and bonding the electrolyte membrane of a precursor material having a first size to the electrolyte membrane of a precursor material having a second size.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIGS. 1A and 1B show the roll bonder for carrying out the present invention according to the GDE/membrane process.

FIGS. 2A and 2B show before and after views of bonding of the present invention according to the GDE/membrane process.

FIGS. 3A and 3B show the before and after bonding of the present invention according to the 2-layer MEA/GDL process.

FIGS. 4A and 4B schematically show the roll bonder for carrying out the present invention according to the 2-layer MEA/GDL process.

FIGS. 5A-5D are views of the bonding of the MEA of the present invention according to the precursor-MEA/GDE process.

FIGS. 6A-6D are views of the before and after bonding of the MEA of the present invention according to the double precursor-MEA process.

FIGS. 7A and 7B show the use of the MEA of the present invention with a bipolar separator plate.

### DETAILED DESCRIPTION OF THE INVENTION

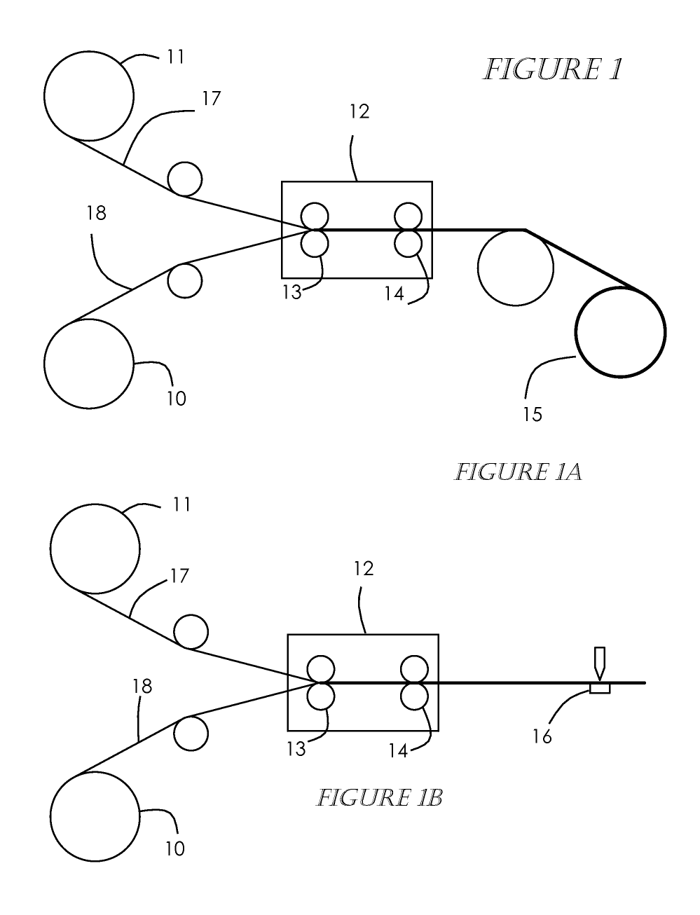

Referring more specifically to the drawings, for illustrative purposes the present invention is embodied in the apparatus and method generally shown in FIG. 1A through FIG. 7B. It will be appreciated that the apparatus may vary as to configuration and as to details of the parts, and that the method may vary as to the specific steps and sequence, without departing from the basic concepts as disclosed herein.

Membrane electrode assemblies (MEAs) are produced in accordance with this invention by combining gas diffusion layers, catalyst/electrodes and a polymer electrolyte membrane in a continuous rolling and bonding process. These components can be combined in various sequences to achieve the end goal of producing a more economical MEA by mechanically stabilizing the flimsy electrolyte membrane material.

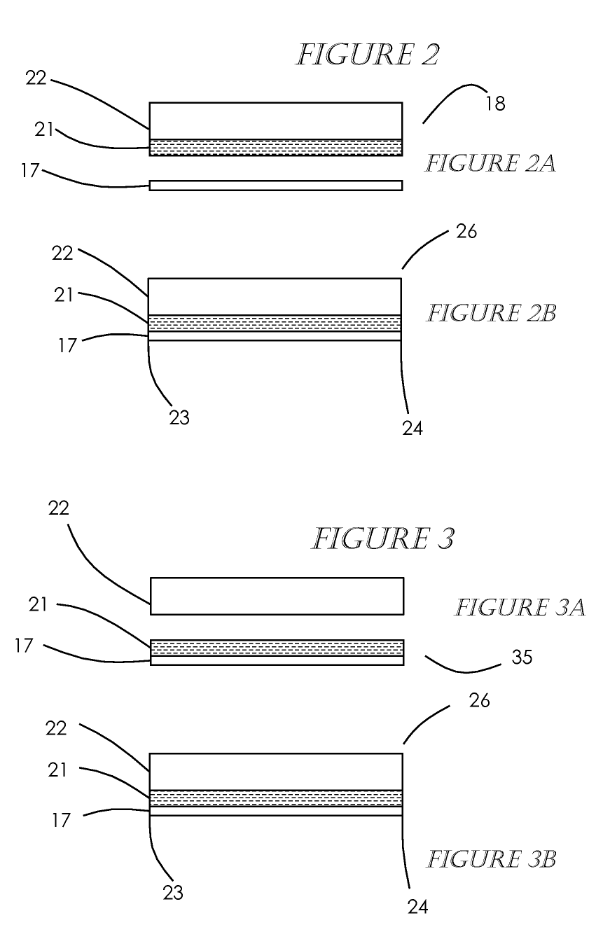

A precursor-MEA is produced in accordance with this invention by attaching or bonding a polymer electrolyte membrane to a gas diffusion layer by one of two preferred embodiments. FIGS. 1A and 1B show a first embodiment, gas diffusion electrode material (GDE) 18 such as that supplied by the E-TEK Division of PEMEAS Fuel Cell Technologies on a roll 10 is mated or bonded with a polymer electrolyte membrane material 17 such NAFION® by DuPont, also supplied on a roll 11, forming a unified structure. The GDE material can preferably be a cathode but can alternately be an anode. The two materials are unwound and roll bonded or laminated with the use of heat 12 at a temperature of about 50 C. to 200 C. and pressure 13, 14 of about 50 psi to 300 psi in such a manner that the catalyst/electrode side of the GDE is in contact with the polymer electrolyte membrane material. The temperature and pressure make the ionomer in the catalyst layer soft and adhesive to provide a good bond between the gas diffusion layer and the catalyst/electrode and between the catalyst/electrode and the polymer electrolyte membrane forming a unified structure. After bonding the precursor-MEA is either rolled for storage 15 or sized by die cutting, shearing or other sizing methods 16 known to those familiar with the art. FIG. 2A shows the GDE 25 and the electrolyte membrane material before bonding. The GDE 18 consists of the catalyst/electrode 21 and the GDL 22 as a unit. The bonded, sized precursor-MEA 26 is shown in cross section in FIG. 2B showing the polymer electrolyte membrane material 17, the catalyst/electrode 21 and the gas diffusion layer 22 as a unified structure. This 3-layer precursor-MEA consists of polymer electrolyte membrane material 17, the catalyst/electrode 21 and the gas diffusion layer 22 as a unified structure. Note that the edges of the polymer electrolyte membrane material 17, the catalyst/electrode 21 and the gas diffusion layer 22 are sized to be flush on the edges 23, 24 as are the other edges of the unified structure which are not shown. As a unified structure, the precursor-MEA has the advantage eliminating the separate handling of the polymer electrolyte membrane material itself because it is bonded to the GDL material in a unified structure, which is easier to manipulate. A variation of this embodiment, rather than continuous roll bonding of the material, is to use individual sections of the materials and hot-press or hot roll the sections of the GDE and the polymer electrolyte membrane material using similar temperatures and pressures to form the unified structure. An additional variation is the formation of the polymer electrolyte membrane in situ by coating the GDE with a NAFION ionomer solution, which is cured as described in the teachings of U.S. Pat. No. 6,641,862, to form the unified structure.

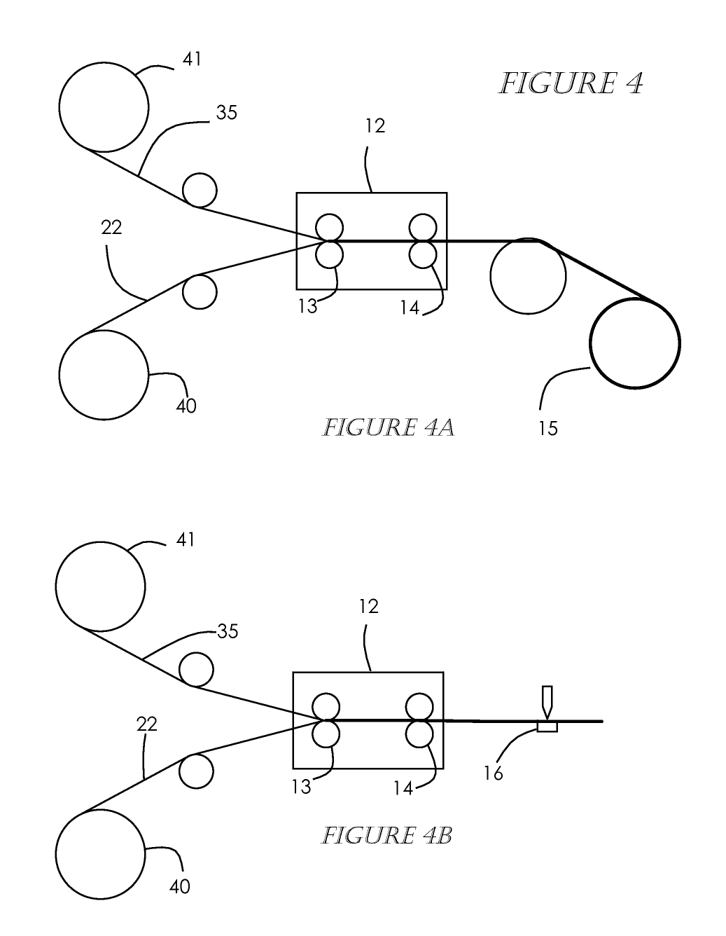

A second embodiment of the method of producing the precursor-MEA, shown in FIGS. 3A-3B, is to use a polymer electrolyte membrane 17 onto which a catalyst/electrode 21 has been applied/bonded to one side of the polymer electrolyte membrane material, forming a 2-layer MEA 35 having the electrolyte membrane material 17 with the catalyst/electrode 21 essentially covering the entire one side of the electrolyte membrane material 17, with no need for borders or frames as is the usual practice. The 2-layer MEA 35 can preferably be a cathode but can alternately be an anode. U.S. Pat. Nos. 6,197,147; 6,933,033; and 6,855,178 teach methods of applying a catalyst/electrode to a polymer electrolyte membrane. Polymer electrolyte material with catalyst/electrodes bonded on is supplied by DuPont, W. L. Gore, and Ion Power, among others. Gas diffusion layer material (GDL) 22 such as that supplied by the E-TEK Division of PEMEAS Fuel Cell Technologies, Toray Industries, Inc. and SGL Carbon AG on a roll 40 is mated or bonded with the 2-layer MEA material 35, also supplied on a roll 41, to form a unified structure (FIGS. 4A-4B). The two materials are unwound and roll bonded or laminated with the use of heat 12 at a temperature of about 50 C. to 200 C. and pressure 13, 14 of about 50 psi to 300 psi in such a manner that the catalyst/electrode side of the 2-layer MEA is in contact with the gas diffusion layer material 22. The temperature and pressure make the ionomer in the catalyst layer soft and adhesive to provide a good bond between the gas diffusion layer and the catalyst/electrode and between the catalyst/electrode and the polymer electrolyte membrane forming the unified structure. After bonding, the precursor-MEA is either rolled for storage 15 or sized by die cutting, shearing or other sizing methods 16 known to those familiar with the art. FIG. 3A shows the GDL 22 and the 2-layer MEA 35 before bonding. The 2-layer MEA consists of the catalyst/electrode 21 and the polymer electrolyte membrane 17 as a unit. The sized precursor-MEA 26 is shown in cross section in FIG. 3B, showing the polymer electrolyte membrane material 17, the catalyst/electrode 21 and the gas diffusion layer 22. This 3-layer precursor-MEA 26 consists of polymer electrolyte membrane material 17, the catalyst/electrode 21, and the gas diffusion layer 22 as a unified structure. Note that the edges of the polymer electrolyte membrane material 17, the catalyst/electrode 21 and the gas diffusion layer 22 are sized to be flush on the edges 23, 24 as are the remaining edges for the unified structure not shown. This precursor-MEA 26 has the advantage of eliminating the handling of the polymer electrolyte membrane material itself, because it is bonded to the GDL material, which is easier to manipulate as a unified structure. A variation of this embodiment is to use individual sections of the materials and hot-press the sections of the GDE and the polymer electrolyte membrane material using similar temperatures and pressures, rather than use continuous roll bonding of the material.

A precursor-MEA is produced in accordance with the second embodiment, shown in FIGS. 4A and 4B, by attaching or bonding a 2-layer MEA 35 to gas diffusion layer 22 in a roll bonding processes. The 2-layer MEA material 35 is supplied on a roll 41 and is mated or bonded with a GDL material 22, also supplied as a roll 40, forming a unified structure. The two materials are unwound and roll bonded or laminated with the use of heat 12 at a temperature of about 50 C. to 200 C. and pressure 13, 14 of about 50 psi to 300 psi in such a manner that the catalyst/electrode 21 side of the 2-layer MEA 35 is in contact with the GDL material 22. The temperature and pressure make the ionomer in the catalyst layer soft and adhesive to provide a good bond between the gas diffusion layer and the catalyst/electrode and between the catalyst/electrode and the polymer electrolyte membrane forming a unified structure. After bonding, the precursor-MEA is either rolled for storage 15 or sized by die cutting, shearing or other sizing methods 16 known to those familiar with the art.

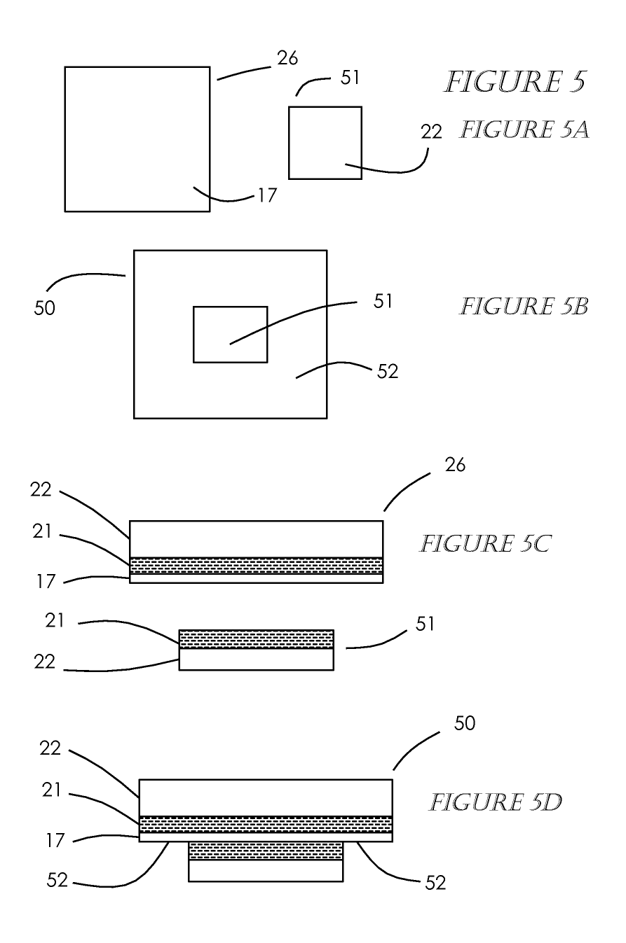

FIGS. 5A-5D are exemplary illustrations for fabricating MEAs from precursor-MEAs 26. FIG. 5A illustrates the sized precursor-MEA 26 from the embodiments described hereinabove showing the polymer electrolyte membrane 17 on the obverse and a sized GDE 51 showing the GDL on the obverse 22, which is sized to be smaller in the planar dimensions than the precursor-MEA 26. If the precursor-MEA 26 is the cathode, the GDE 51 is an anode; conversely, if the precursor-MEA is an anode, then the GDE 51 is a cathode. The precursor-MEA 26 and the GDE 51 are brought into registration (FIG. 5B) by means of transport, feeding and registering devices known to those familiar with the art. The placement of the sized precursor-MEA 26 is such that there is a border area 52 continuously around and outboard of the sized GDE 51. This border area is the exposed supported polymer electrolyte membrane 17 of the precursor-MEA 26. FIG. 5C shows the cross sectional configuration of the sized precursor-MEA 26 and the second sized GDE 51 before bonding. The polymer electrolyte membrane 17 of the precursor-MEA 26 is caused to contact the catalyst/electrode 21 of the sized GDE 51. The two components, the polymer electrolyte membrane 17 of the precursor-MEA 26 and the catalyst/electrode 21 (not shown) of the sized GDE 51 are laminated and bonded by hot-pressing or roll bonding with the use of heat at a temperature of about 50 C. to 200 C. and pressure of about 50 psi to 300 psi in such a manner that the catalyst/electrode side 21 of the GDE is in contact with the polymer electrolyte membrane 17 of the precursor-MEA 26. The temperature and pressure make the ionomer in the catalyst layer soft and adhesive to provide a good bond between the gas diffusion layer of sized GDE 51 and the and the polymer electrolyte membrane 17 layer of the precursor-MEA 26. FIG. 5D shows a cross section of the bonded or laminated MEA 50 showing the border area 52 which extends outboard from the bonded GDE 51. In a variation of this embodiment, the border area 52 is eliminated and the edges 54, 55 of the sized GDE 51 extend to be coincident with the edges 23, 24, shown, of the precursor-MEA 26. The remaining edges of the sized GDE 51, not shown, extend to be coincident with the corresponding edges, not shown, of the precursor-MEA 26.

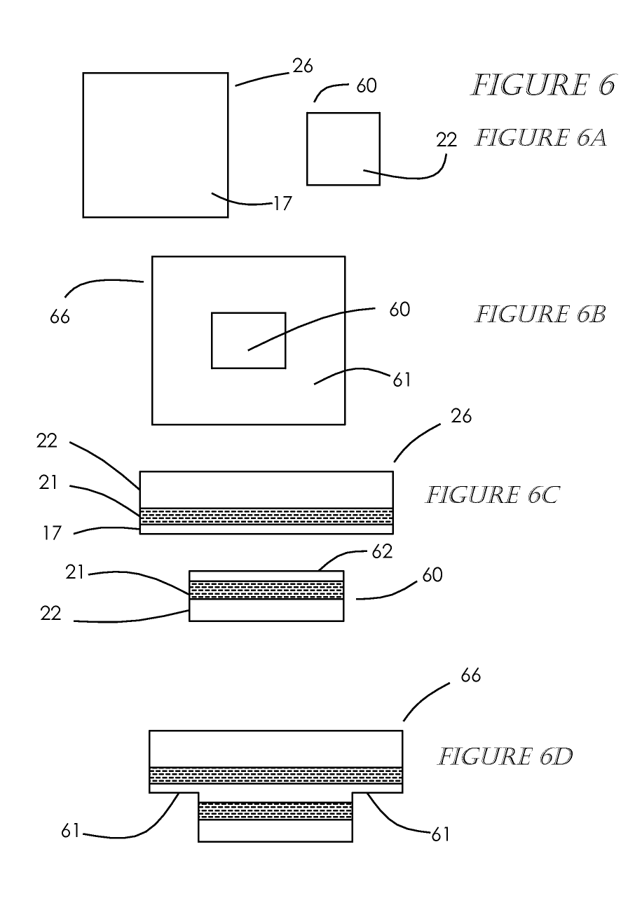

An alternate embodiment for fabricating MEAs from precursor-MEAs 26 is shown in the exemplary illustrations of FIGS. 6A-D. FIG. 6A illustrates a first sized precursor-MEA 26 from the embodiments described hereinabove showing the polymer electrolyte membrane 17 on the obverse and a second sized precursor-MEA 60 showing the GDL on the obverse 22 which is sized to be smaller in both planer dimensions than the first precursor-MEA 26. If the first precursor-MEA 26 is the cathode, then the second sized precursor-MEA 60 is an anode; conversely, if the precursor-MEA is an anode, then the second sized precursor-MEA 60 is a cathode. The first precursor-MEA 26 and the second precursor-MEA 60 are brought into registration, FIG. 6B, by means of transport, feeding and registering devices known to those familiar with the art. The placement of the second precursor-MEA 60 is such that there is a border area 61 continuously around and outboard of the second precursor-MEA 60. This border area is the exposed supported polymer electrolyte membrane 17 of the first precursor-MEA 26. FIG. 6C shows the cross sectional configuration of the first sized precursor-MEA 26 and the second sized precursor-MEA 60 before bonding. The polymer electrolyte membrane 17 of the first precursor-MEA 26 is caused to contact the polymer electrolyte membrane 62 of the second precursor-MEA 60. The two components, the polymer electrolyte membrane 17 of the first precursor-MEA 26 and the polymer electrolyte membrane 62 of the second precursor-MEA 60 of the second precursor-MEA 60, are laminated and bonded by hot-pressing or roll bonding with the use of heat at a temperature of about 50 C. to 200 C. and pressure of about 50 psi to 300 psi in such a manner that the electrolyte membrane 17 of the first precursor-MEA 26 is in contact with the polymer electrolyte membrane 62 of the second precursor-MEA 60. The temperature and pressure make the polymer electrolyte membrane 17 of the first precursor-MEA 26 and the polymer electrolyte membrane 62 of the second precursor-MEA 60 soft and adhesive to provide a good bond between the polymer electrolyte membrane 17 of the first precursor-MEA 26 and the polymer electrolyte membrane 62 of the second precursor-MEA 60. FIG. 6D shows a cross section of the bonded or laminated MEA 50 showing the border area 61 which extends outboard from the bonded second precursor-MEA 60. In a variation of this embodiment, the border area 61 is eliminated and the edges, 67, 68 of the second sized precursor-MEA 60 extend to be coincident with the edges 23, 24, shown, of the first precursor-MEA 26. The remaining edges of the second precursor-MEA, not shown, extend to be coincident with the corresponding edges, not shown, of the first precursor-MEA 26.

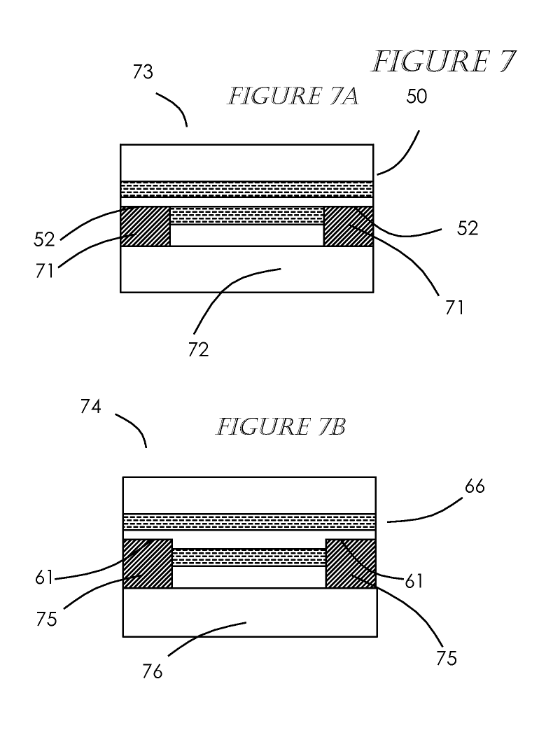

Referring to FIGS. 7A and 7B, the border areas 52, 61 are used as sealing or bonding surfaces to seal or bond the MEAs 50, 66 to an adjacent bipolar separator plate 72, 76 in an arrangement known to those proficient in the art. The seals or bonds 71, 75 are gaskets, gaskets incorporating adhesives, o-rings, pressure sensitive adhesives with or without a carrier gasket, liquid or semi-liquid adhesives. Any adhesives or gaskets incorporating adhesives necessarily must form an adequate bond with the bipolar separator plates 72, 76 and the membrane electrode assemblies' 50, 66 border areas 52, 61 and between the bipolar separator plates 72, 76 and the membrane electrode assembly 50, 66. Below are a few examples of adhesives, which may be of use in bonding the MEAs and manifolds to the BSPs:

Specific commercial tapes of the 3M Corp. (of St. Paul, Minn.) family of VHB (Very High Bond) Tapes, such as product number 4920, a closed-cell acrylic foam carrier with adhesive, or F-9469 PC, an adhesive transfer tape (trademarks of the 3M Company of St. Paul Minn.).

Commercial acrylic adhesives such as Loctite Product 312 or 326 (trademark of the Loctite Corporation of Rocky Hill, Conn.) or 3M Scotch-Weld Acrylic Adhesive such as DP-805 or DP-820 (trademark of the 3M Company St. Paul Minn.).

Specific epoxy products such as 3M 1838 (trademark of the 3M Company of St. Paul Minn.) or Loctite E-20HP. (Trademark of the Loctite Corporation of Rocky Hill, Conn.)

These examples are not to imply the only materials applicable to the bonding of the MEAs and the BSPs, but only illustrate some of the suitable materials that can be selected by those skilled in the art. These materials are applied with the typical methods made use of by those skilled in the art such as hand or robotic placement, hand or robotic dispensing, screen or stencil printing, rolling and spraying.

While only a few embodiments of the invention have been shown and described herein, it will become apparent upon reading this application to those skilled in the art that various modifications and changes can be made to provide MEAs for fuel cells in a fully functioning fuel cell device without departing from the spirit and scope of the present invention. The present approach to produce a novel fuel cell MEA is applicable to generally any cell geometry or configuration, such as rectangular, square, round or any other planar geometry or configuration. All such modifications and changes coming within the scope of the appended claims are intended to be carried out thereby.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1-3. (canceled)

4. A method of making a membrane electrode assembly, comprising:
coating an electrolyte membrane with catalyst/electrode material;
attaching gas diffusion layer (GDL) material over said coating of catalyst/electrode material to form a precursor material;
sizing said precursor material;
preparing a gas diffusion electrode (GDE) material;
sizing said GDE material; and
bonding said GDE material to said electrolyte membrane.

5. A method as recited in claim 4:
wherein planar dimensions of said GDE material are smaller than planar dimensions of said precursor material.

6. A method as recited in claim 4:
wherein the step of attaching GDL material is performed using a roll-bonding machine.

7-8. (canceled)

9. A method of making a membrane electrode assembly, comprising:
coating an electrolyte membrane with catalyst/electrode material;
attaching gas diffusion layer (GDL) material over said coating of catalyst/electrode material to form a precursor material;
sizing said precursor material;
wherein said sized precursor material has either a first size or a second size;
wherein said first size is larger than said second size; and
bonding said electrolyte membrane of a precursor material having a first size to said electrolyte membrane of a precursor material having a second size.

10. A method of making a membrane electrode assembly, comprising:
coating a first electrolyte membrane layer with a first catalyst/electrode layer;
attaching a first gas diffusion layer (GDL) to said first catalyst/electrode layer and said first electrolyte membrane layer to support said first catalyst/electrode layer and said first electrolyte membrane layer on said first GDL;
said first electrolyte membrane layer, first catalyst/electrode layer and first GDL forming a first unified structure;
coating a second electrolyte membrane layer with a second catalyst/electrode layer;
attaching a second gas diffusion layer (GDL) to said second catalyst/electrode layer and said second electrolyte membrane layer to support said second catalyst/electrode layer and said second electrolyte membrane layer on said second GDL;
said second electrolyte membrane layer, second catalyst/electrode layer and second GDL forming a second unified structure; and
attaching said first unified structure to said second unified structure such that the second catalyst/electrode layer of said second unified structure contacts said first electrolyte membrane layer of said first unified structure.

11. A method as recited in claim 10, wherein said first GDL and said first catalyst/electrode layer have identical planar dimensions and said second GDL and said second catalyst/electrode layer have identical planar dimensions.

12. A method as recited in claim 10:
wherein planar dimensions of said second unified structure are smaller than planar dimensions of said first unified structure.

13. A method as recited in claim 10:
wherein the first GDL material is attached or bonded to said first electrolyte membrane layer by hot rolling or laminating over the entire surface of the electrolyte membrane layer.

14. A method as recited in claim 10:
wherein the first catalyst/electrode layer coats the entire surface of the first electrolyte membrane layer.

15. A method as recited in claim 10, wherein said electrolyte membrane material comprises a polymer electrolyte membrane (PEM) material.

16. A method as recited in claim 4:
wherein said GDL material supports said catalyst/electrode material and said electrolyte membrane layer.

17. A method as recited in claim 4:
wherein the catalyst/electrode material coats the entire surface of the electrolyte membrane material.

18. A method as recited in claim 17:
wherein the catalyst/electrode material, the electrolyte membrane material and the GDL material have identical planar dimensions.

19. A method as recited in claim 9:
wherein said GDL material supports said catalyst/electrode material and said electrolyte membrane layer.

20. A method as recited in claim 9:
wherein the catalyst/electrode material coats the entire surface of the electrolyte membrane material.

21. A method as recited in claim 20:
wherein the catalyst/electrode material, the electrolyte membrane material and the GDL material have identical planar dimensions
